(19) United States
(12) Patent Application Publication
(10) Pub. No.: US 2004/0140907 A1
(43) Pub. Date: Jul. 22, 2004

(54) User programmable universal industrial wireless control system

(76) Inventors: Alfred John Morin II, Woods Cross, UT (US); John William Brown, Holladay, UT (US)

Correspondence Address: FIREFLY REMOTE CONTROLS INC, SUITE 104, 1101 MAIN ST., PMB 143, EVANSTON, WY, 82930, US

(21) Appl. No.: 10/349,367

(22) Filed: Jan. 22, 2003

(51) Int. Cl. G08C 19/00

(52) U.S. Cl. 340/825.72

(57) ABSTRACT

A user programmable universal industrial wireless control system for remotely controlling industrial equipment. The industrial control system includes relay systems that are connected with a stopping and starting system of the industrial equipment. The industrial control system, according to the signals received from the transmitter, causes the relay systems to be either energized or de-energized as required to start and/or stop the industrial equipment. The relay systems are user programmable to be either momentary, maintained, or have timer functions.

### BACKGROUND OF THE INVENTION

1. The Field of the Invention

The present invention relates to remotely controlling industrial equipment. More particularly, the present invention relates to systems and methods for remotely starting and stopping different types of industrial equipment.

2. Background and Relevant Art

Industrial equipment comes in many different forms. The different types of industrial equipment serve a variety of purposes. Industrial motors, lights, pumps, doors, irrigation equipment are examples of just a few of many different types of industrial equipment. The different types of industrial equipment reflect the various industries that might use these types of equipment.

For whatever its use, industrial equipment is frequently turned on and then off for various reasons. This frequent turning on and off of equipment serves to save energy and possible emissions into the air. Another reason to turn equipment on then off is because the equipment is used solely for short periods of time. It can be disadvantageous to have the equipment running continuously. Thus industrial equipment is often stopped and started repeatedly. While these different types of industrial equipment are an important part of many jobs, the equipment can be located in a remote area from the operator.

To combat this problem, a wireless control can make an operator's job much easier to accomplish. A pump for example may be used to deliver water to various locations that may be far away from the actual location of the operator. In order to start the pump the operator would have to stop whatever he or she is doing to go to the location of the pump to stop or start it. A wireless control simplifies this by stopping or starting the pump remotely from a long distance. Another example of industrial wireless control may be a farmer who would use a wireless control for the start and stop of irrigation equipment.

### BRIEF SUMMARY OF THE INVENTION

Industrial equipment is manufactured in a variety of different types that include industrial motors, lights, pumps, doors, irrigation equipment just to name a few. The present invention relates to systems and methods for remotely controlling these types of industrial equipment. The present invention provides circuitry that is able to integrate with the existing starting stopping systems of industrial equipment.

A user programmable universal industrial wireless control system includes a receiver circuit that receives and processes signals received from a wireless transmitter. The receiver circuit then activates or asserts an output signal(s) according to the signal that was received from the transmitter. The output signal(s) are used to control relay systems that are connected with the industrial equipment.

One of the relay systems is energized as long as the transmitter is sending the signal to the receiver circuit. This is useful, for example, in activating the starting system of the industrial equipment. Another relay system is typically connected to the receiver circuit through a circuit component that maintains the relay system in an energized state even after the transmitter is no longer transmitting. The relay system thus remains energized and the start system is able to continue functioning as required. The control system can be shut down by de-asserting the signal that controls this relay system, thereby de-energizing the relay system and shutting down the industrial equipment. The ability to control whether a relay system is energized enables the industrial control system to be connected to more than one industrial equipment type. This is accomplished by the user programming the mode of the output relays.

The user can thus program the receiver such that the output relays are either momentary, maintained, or have timer functions.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram showing the functionality of a user programmable universal industrial wireless control system.

FIG. 2 is a wiring schematic showing the functionality of a radio transmitter.

FIG. 3 is a wiring schematic showing the functionality of a radio receiver.

FIG. 4 is a table showing the modes of the user programmable relays.

### DETAILED DESCRIPTION OF THE PREFERRED EMBODIMENTS

The present invention relates to industrial equipment control systems for use in remotely controlling industrial equipment. The present invention can be used with equipment in industrial, commercial, and recreational industries. The types of industrial equipment that can be remotely controlled by the present invention include, but are not limited to, industrial motors, lights, pumps, doors, irrigation equipment, and the like. This equipment can be portable or stationary. One advantage of the present invention is that it can be used to remotely control more than one type of industrial equipment using the same circuitry.

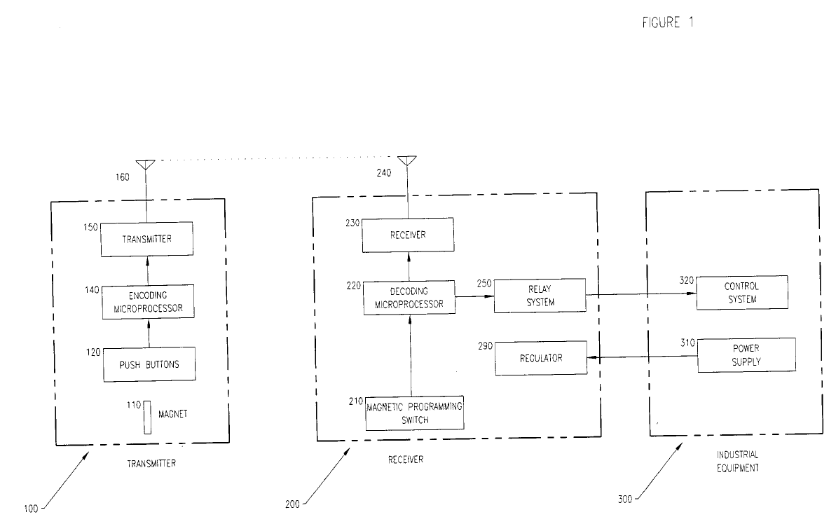

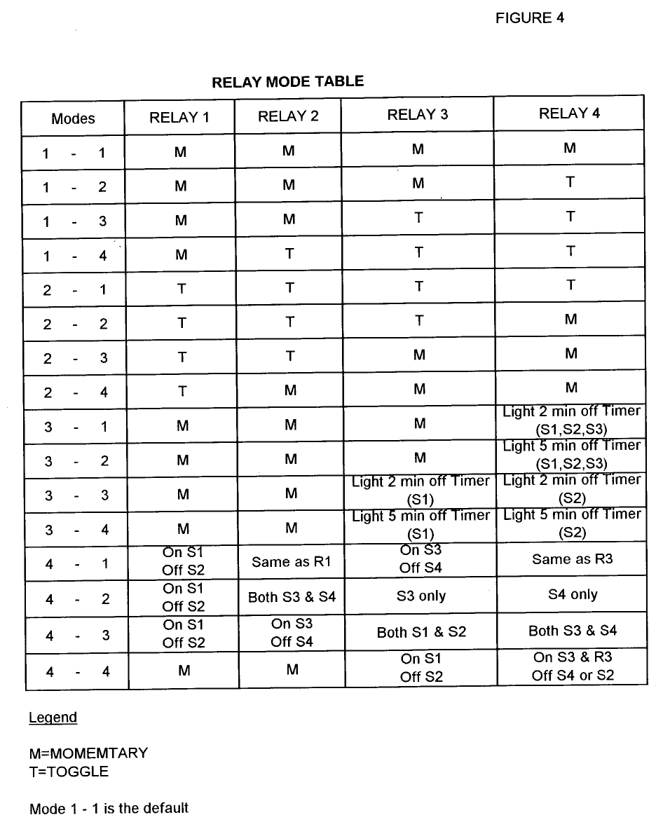

FIG. 1 illustrates a wireless receiver 200 that is coupled or connected with industrial equipment 300. The industrial equipment 300 includes a control system 320 and a battery or power supply 310. As previously stated, control system is intended as representative of the control systems of various industrial equipment types, even though the specific implementation of control systems and vary across industrial equipment types. The control system of an electric pump, for instance, is different from the control system of an electric operated door. Specific implementations are discussed with reference to FIG. 4.

The wireless receiver 200 is typically mounted in parallel to the existing control system 320 of the industrial equipment 300. Mounting or connecting wireless receiver 200 in this manner ensures that the industrial equipment 300 can be controlled independently of the wireless receiver 200. An electric pump, for example, can be started and stopped with either a local control station or the wireless receiver 200. Typically, the wireless receiver 200 has a master switch that disables the wireless receiver 200. This prevents, for example, the industrial equipment 300 from being remotely started or stopped inadvertently. The master switch is often used when maintenance is being performed on the industrial equipment 300 and protects the operator from injury should someone attempt to remotely start the industrial equipment 300.

The wireless receiver 200 includes a relay system 250 which is comprised of 4 or more relays. Each of these relays can be used to control various functions of the industrial equipment 300. For example start, stop, left, right, up, down, on, off, forward, reverse, fast, slow, etc. The regulator 290 is typically coupled to the battery or power supply 310 of the industrial equipment 300 and is used to provide the appropriate level of power to the various components of the wireless receiver 200. The output of the regulator 290 is typically about 5 volts.

The voltage supplied to the receiver circuit 230 is reduced in this example. The voltage supplied to the decoding microprocessor 220 is also reduced in order to ensure that the outputs of the receiver circuit 230 are recognized.

The receiver circuit 230 receives encoded command signals (start signals and stop signals, for example) from the transmitter 100. These signals are typically used to both start and stop the industrial equipment 300. The decoding microprocessor 220, depending upon the signal received from the transmitter 100, will emit control signals or assert outputs that are sent to the relay systems 250. The decoding microprocessor 220 can be user programmed to have 16 or more output modes. For example, mode 1-1 is to have all relays momentary. Mode 1-2 is to have one of the relays toggle and the remaining momentary. Specific implementations are discussed with reference to FIG. 4.

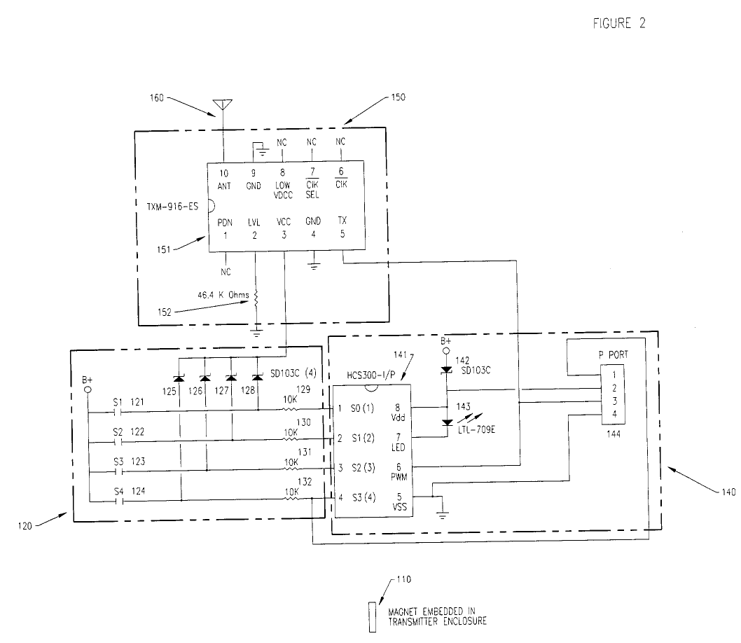

FIG. 2 is a schematic diagram that more fully illustrates an exemplary embodiment of the transmitter 100 shown in FIG. 1.

4 or more pushbutton switches 121(S1), 122(S2), 123(S3), 124(S4) are used as inputs to the encoding microprocessor 141. Schottky diodes 125, 126, 127, 128 provide power to the transmitter integrated circuit 151 when a pushbutton 121(S1), 122(S2), 123(S3), 124(S4) is pressed. Resistors 129, 130, 131, 132 limit the current to the encoding microprocessor 141 when a pushbutton 121(S1), 122(S2), 123(S3), 124(S4) is pressed under a reverse polarity condition (i.e. the batteries are in backwards).

The encoding microprocessor 141 is connected to the pushbutton circuit 120. The encoding microprocessor 141 has an internal serial number programmed into its memory. Each and every encoding microprocessor 141 manufactured will have a unique serial number. A firmware algorithm in the encoding microprocessor 141 combines the pushbutton input information 120, its unique serial number, and an encrypted revolving code into a 66 or more bit transmission word. Schottky diode 142 provides polarity protection to the encoding microprocessor 141. Light emitting diode 143 indicates that a pushbutton 121(S1), 122(S2), 123(S3), 124(S4) has been pressed and the batteries are normal. Light emitting diode 143 will blink when the batteries are low while a pushbutton 121(S1), 122(S2), 123(S3), 124(S4) is pressed.

Programming (P) port 144 is used to download the unique serial number to the encoding microprocessor 141.

Transmitter integrated circuit 151 is connected to the encoding microprocessor 141. The encoded data from the encoding microprocessor 141 is modulated by the transmitter integrated circuit 151 into a radio frequency signal that is emitted from the transmitter antenna 160. Resistor 152 is used to control the output level of the transmitter integrated circuit to be within Federal Communication Commission standards.

Magnet 110 is embedded in the transmitter enclosure and is used to user program the receiver 200 (as shown in FIG. 1). The transmitter is placed in proximity of the receiver 200 to activate the magnetic programming switch 210.

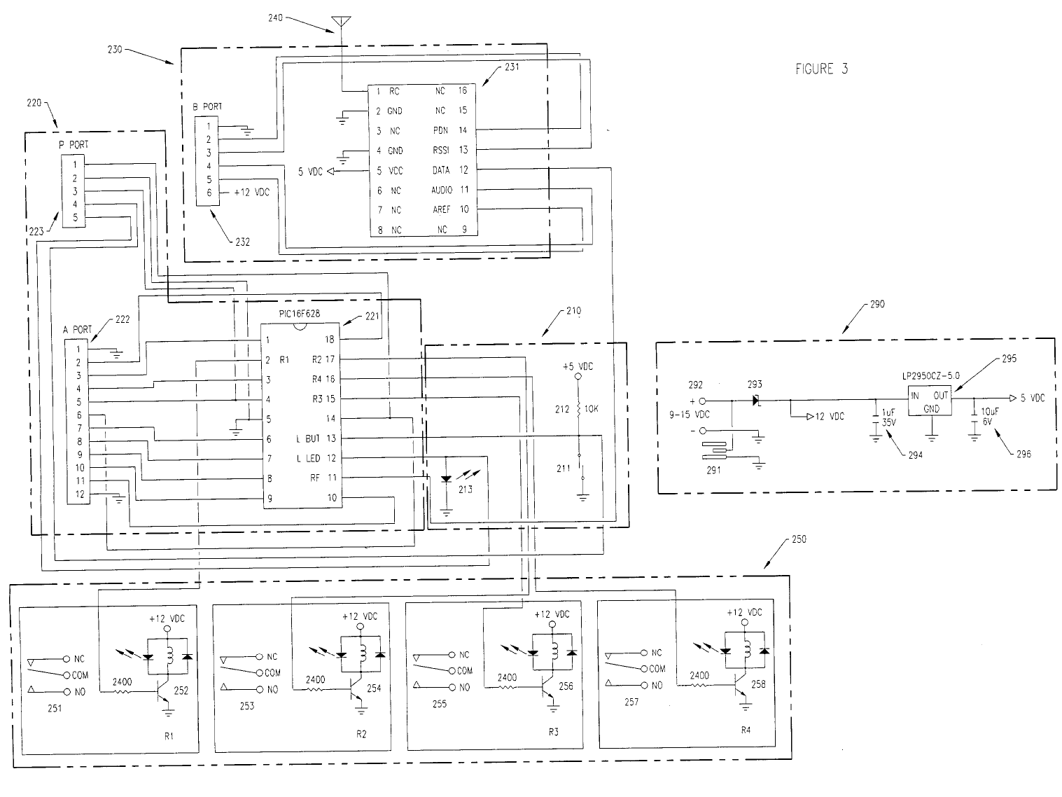

FIG. 3 is a schematic diagram that more fully illustrates an exemplary embodiment of the receiver 200 (as shown in FIG. 1). Antenna 240 receives emitted radio frequency signals from transmitter 100 (as shown in FIG. 1). The radio receiver integrated circuit 231 demodulates the encrypted 66 or more bit transmitted word. The data output of the radio receiver integrated circuit 231 is connected to the decoding microprocessor 221. The decoding microprocessor 221 decrypts the data word and compares the serial number of the transmitter 100 (as shown in FIG. 1). Only a transmitter 100 (as shown in FIG. 1) with its serial number recorded in the decoding microprocessor 221 will be recognized and will activate the receiver 200 (as shown in FIG. 1) output functions. The (B) port 232 is used for test purposes. The magnetic programming switch 211 is used for 3 functions. The first is used to clear the decoding microprocessor 221 memory of stored transmitter 100 (as shown in FIG. 1) serial numbers. This is done by holding the transmitter 100 (as shown in FIG. 1) in proximity of the magnetic programming switch 210 for a period of 10 seconds or until the light emitting diode 211 flashes off. The second function is to instruct the decoding microprocessor 221 to learn a new transmitter 100 (as shown in FIG. 1) serial number. This is done by bringing the transmitter 100 (as shown in FIG. 1) in proximity of the magnetic programming switch 211 for 1 second or until the light emitting diode 213 turns on. A pushbutton on the transmitter must then be pressed within a 15 second period. Once the transmitter is learned, the light emitting diode 213 will flash twice. This learning process can be repeated so that the decoding microprocessor 221 can record 15 or more transmitter serial numbers. The third function is to instruct the decoding microprocessor 221 to accept user programmable output functions. This is done by bringing the transmitter 100 (as shown in FIG. 1) in and out of proximity of the magnetic programming switch 211 four times within a 2 second period. The light emitting diode 213 will flash at a fast rate to indicate the decoding microprocessor 221 is in the user programmable mode. A sequence of two pushbuttons must be pressed on the transmitter 100 (as shown in FIG. 1) in order to select the desire function. For example if the user wants all of the relays to be momentary, the programming sequence is to press pushbutton 1, 121(S1) (as shown in FIG. 2), wait 1 second then press pushbutton 1, 121(S1) (as shown in FIG. 2) again. When the pushbutton is pressed the first time, the light emitting diode 213 will change to a slow blink. After the pushbutton is pressed again, the light emitting diode 213 will turn off. If the user fails to input the proper sequence within 15 seconds, the decoding microprocessor 221 will not accept the change. Specific implementations are discussed with reference to FIG. 4.

Resistor 212 is used to pull the voltage on the input of the decoding microprocessor 221 high when the magnetic programming switch 211 is not being used. (P) port 223 is used to download firmware to the decoding microprocessor 221. (A) port 222 is for additional relays.

Voltage regulator components 294, 295, 296 are used to filter and reduce voltage to 5 volts that is needed by the decoding microprocessor 221 and the radio receiver integrated circuit 231. Schottky diode 293 is used for reverse polarity protection. Regulator 290 is connected to the power supply 310 (as shown in FIG. 1) to terminals 292 or to connector 291. Outputs from the decoding microprocessor 221 are used to drive the base of transistors 252, 254, 256, 258 which energizes relays 251, 253, 255, 257. Normally open or normally closed contacts from relays 251, 253, 255, 257 interface to the control system 320 (as shown in FIG. 1) as per user requirements.

FIG. 4 is a table of available modes of the receiver 200 (as shown in FIG. 1). These output functions are user programmable as per the users requirements. The different modes are programmed by steps previously discussed in paragraph 027. At present there are 16 functions shown. The number of modes can be expanded to include additional features as required. The modes available include many combinations of momentary, toggle, on, off, and timers. Industrial equipment comes in many different forms. The different types of industrial equipment serve a variety of purposes. Industrial motors, lights, pumps, doors, irrigation equipment are just a few examples of many different types of industrial equipment. The modes that are in this table are designed to be as universal as possible to be able to control a wide variety of industrial equipment. Of equal importance, the user must select the mode that will meet the requirements of the specific equipment to be controlled.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A user programmable universal industrial wireless control system for remotely controlling industrial equipment comprising:
at least 1 transmitter with pushbuttons or switches that are used for both control of the industrial equipment and for the user programmability of the receiver.
at least 1 receiver with output relays that are user programmable to required modes.

2. a wireless control system as defined in claim 1 in which the user selects a pre determined program stored as firmware in the receiver.

3. a wireless control system as defined in claim 1 in which a magnet is embedded in the transmitter and a magnetic switch is located in the receiver. The transmitter is placed in proximity of the receiver to activate the magnetic switch which activates the user programming function.

4. a wireless control system as defined in claim 1 in which the receiver has a pushbutton switch to activate the user programming function.

5. a wireless control system as defined in claim 1 in which electromagnetic radiation (radio) signals are used for wireless transmissions.

6. a wireless control system as defined in claim 1 in which optical signals are used for wireless transmissions.

7. a wireless control system as defined in claim 1 in which acoustic signals are used for wireless transmissions.

8. a wireless control system as defined in claim 1 in which frequency modulation is used for wireless transmissions.

9. a wireless control system as defined in claim 1 in which frequency hopping spread spectrum modulation is used for wireless transmissions.

10. a wireless control system as defined in claim 1 in which pulse width modulation is used for wireless transmissions.

11. a wireless control system as defined in claim 1 in which electric lighting systems are controlled.

12. a wireless control system as defined in claim 1 in which electric pumps are controlled.

13. a wireless control system as defined in claim 1 in which electric operated doors and or gates are controlled.

14. a wireless control system as defined in claim 1 in which electric operated valves are controlled.

15. a wireless control system as defined in claim 1 in which heating and air conditioning systems are controlled.

16. a wireless control system as defined in claim 1 in which industrial engines are controlled.

17. a wireless control system as defined in claim 1 in which conveyors are controlled.

18. a wireless control system as defined in claim 1 in which transmitted word from transmitter to receiver is encrypted and uses a revolving code technology (code hopping).

19. a wireless control system as defined in claim 1 in which emergency shutdown systems are controlled.

20. a wireless control system as defined in claim 1 in which draw bridges are controlled.

21. a wireless control system as defined in claim 1 in which escalators and or elevators are controlled.

22. a wireless control system as defined in claim 1 in which industrial cranes are controlled.

23. a wireless control system as defined in claim 1 in which carnival and or amusement rides are controlled.
